(19) United States
(12) Patent Application Publication
(10) Pub. No.: US 2003/0184035 A1
(43) Pub. Date: Oct. 2, 2003

(54) Cart for electric or electronic devices having a testing function

(76) Inventor: Hyo-Sun Yu, Dong-gu (KR)

Correspondence Address: CANTOR COLBURN, LLP, 55 GRIFFIN ROAD SOUTH, BLOOMFIELD, CT, 06002

(21) Appl. No.: 10/404,350

(22) Filed: Mar. 31, 2003

(30) Foreign Application Priority Data
Apr. 1, 2002 (KR) 20-2002-0009716

(51) Int. Cl. B62B 3/00

(52) U.S. Cl. 280/47.35; 280/79.3

(57) ABSTRACT

The present invention relates to a cart for electric or electronic devices having a testing function, and more particularly to the cart that can transport electric or electronic devices and test the function of the loaded devices. The cart includes a support frame, a carrying means mounted on the bottom of the support frame, a loading member arranged in the support frame, and input/output devices for inputting the test conditions and outputting the test results. According to the present invention, the loading and testing of electric or electronic devices can be performed simultaneously, resulting in a simplified testing process and significantly reduced testing time.

### TECHNICAL FIELD

The present invention relates to a cart for electric or electronic devices having a test function, and more particularly to the cart that can carry electric or electronic devices and test the function of the loaded devices.

### BACKGROUND OF THE INVENTION

The conventional cart as shown in FIG. 1 is typically used for loading and carrying a variety of goods, whereas the cart for electric or electronic devices is used to load or carry systems or parts of the system. In an old-style test with the conventional cart, a user must set up the system and testing devices, change the system after testing, and then reset up the system and testing devices for each test. Moreover, when testing in a predetermined environmental condition such as temperature or humidity, a user must move the cart loaded with the system and testing devices into the testing chamber and then replace the system, all of which requires a long time and can be quite burdensome.

For example, when testing the computer system, a user loads the mouse, keyboard, and monitor on the cart and proceeds to test the whole system by connecting the loaded mouse, keyboard, and monitor to an untested system per each system. Furthermore, there is a limit in the number of IP addresses that can be used, so the user must connect and disconnect each system to the IP router to make a network test. The significant time being spent and tedious testing that proceeds in this way increase the manufacturing time and even reduce the confidence of testing.

### SUMMARY OF THE INVENTION

It is an object of the present invention to provide a cart for electric or electronic devices that can not only loads and carry the systems but also test the loaded systems without replacing keyboard, mouse and monitor.

It is another object of the present invention to provide a cart for electric or electronic devices that can perform the network test easily with limited IP addresses.

It is still another object of the present invention to provide a cart for electric or electronic devices that can perform an endurance test in predetermined temperature and humidity.

To accomplish the above-mentioned objects, there is provided a cart including a support frame, a carrying means mounted on the bottom of the support frame, loading member arranged in the support frame, and input/output devices for inputting the test conditions and outputting the test results.

The loading member defines plural loading spaces for the systems to be tested. A user can perform the test by controlling the input/output devices connected by connection cables to the systems to be tested via connection box.

And the loading member includes plural racks, connection box including plural sets of input/output ports for the systems to be tested and one set of input/output ports for the input/output devices, and the connection cables to connect each of the ports. The test is prepared by loading the systems on the racks and inserting free end of the connection cables into the ports of the systems to be tested. The test process is quite simplified by eliminating the step of connecting and disconnecting the monitor, mouse and keyboard to each system respectively. Therefore, the time for testing can be significantly reduced.

The connection box includes one set of input/output ports to be connected to the input/output devices and plural sets of input/output ports to be connected to the ports of the systems to be tested. The ports between connection box and the input/output devices are always connected, whereas the ports between connection box and the systems can be connected and disconnected during the test. So the test signals from the input/output devices are transmitted to the systems via connection box by connection cables.

The input/output devices include input devices and output devices. Preferably, the input devices can be at least one device selected from a group consisting of mouse and keyboard, and the output devices can be at least one device selected from a group consisting of monitor and printer. In one aspect of the present invention, the input/output device consists of a monitor, mouse and keyboard. Alternatively, a monitor and keyboard can be integrated in one body. Also the keyboard and mouse can be located whthin a drawer to efficiently utilize the space.

When the systems to be tested include networking function, the cart can include network router to form a local area network (LAN) among the systems for the test of networking function.

The cart can also include a constant temperature and humidity chamber to perform a stability test in a certain environment such as predetermined temperature and humidity. Preferably, the loading member includes covers in the front and rear faces of the loading member to keep the temperature and humidity constant.

Also, preferably, wheels can be used as the carrying means, but need not to be limited wheels since another carrying means such as a rail can be adopted.

### BRIEF DESCRIPTION OF THE DRAWINGS

The above objects and other advantages of the present invention will become more apparent by detailed describing preferred embodiments thereof with reference to the attached drawings in which:

FIG. 1 is a perspective view of a conventional carrying cart;

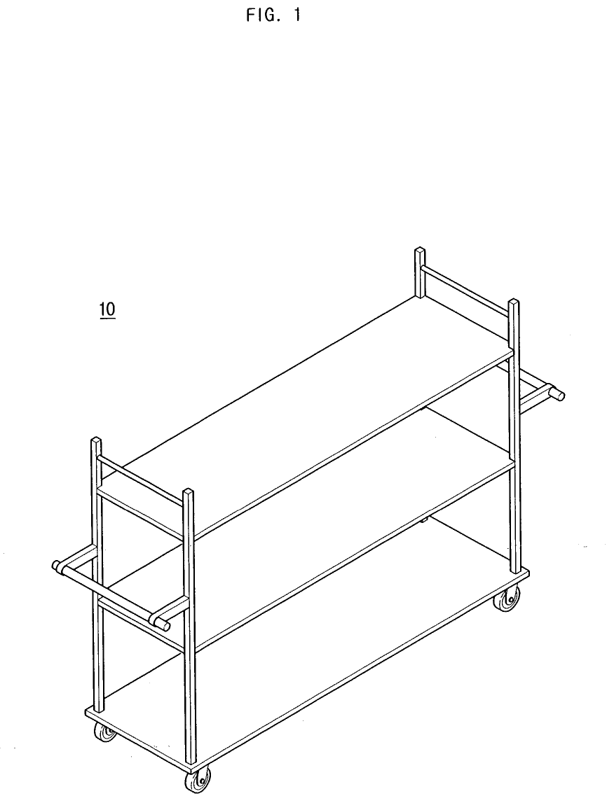

FIG. 2 is a front view of a cart for electric or electronic devices in accordance with the first preferred embodiment of the present invention;

FIG. 3 is a rear view of the embodiment in FIG. 2;

FIG. 4 is an enlarged perspective view of the input/output devices in FIG. 2; and

FIG. 5 is a front view of a cart for electric or electronic devices in accordance with the second preferred embodiment of the present invention.

### EMBODIMENTS

Hereinafter, preferred embodiments of the present invention will be described in more detail with reference to the accompanying drawings, but it is understood that the present invention should not be limited to the following embodiments.

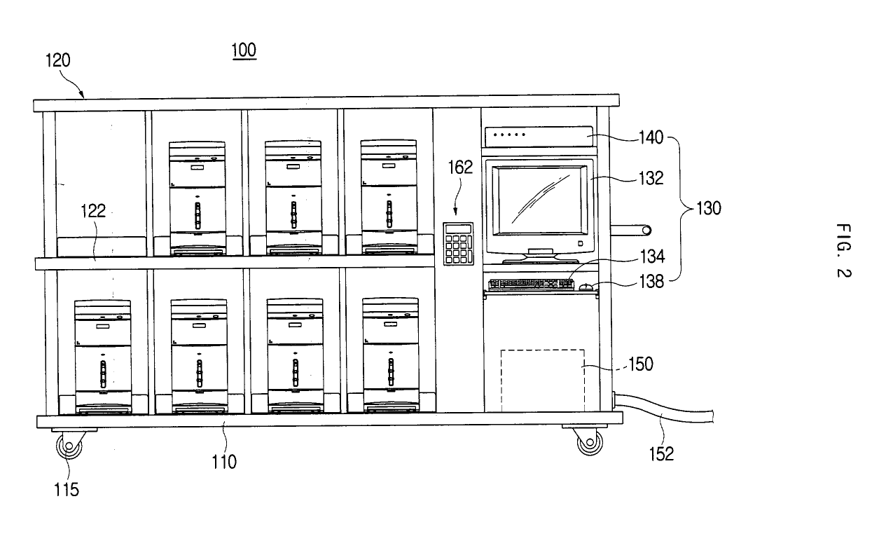

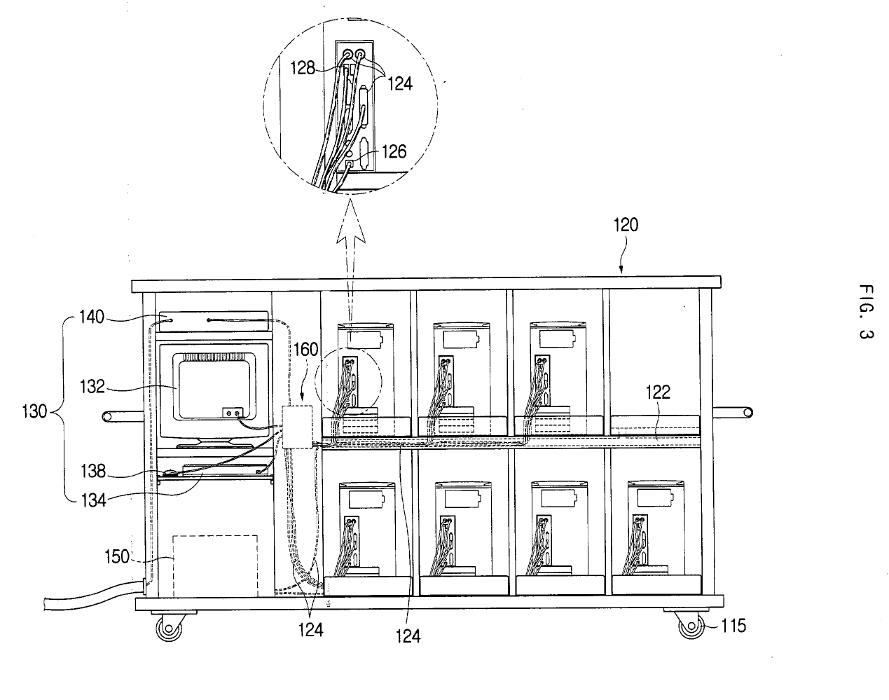

FIG. 2 is a front view of a cart for electric or electronic devices in accordance with the first preferred embodiment of the present invention, and FIG. 3 is a rear view of the embodiment in FIG. 2.

Referring to FIG. 2 and FIG. 3, the cart 100 in the first preferred embodiment is for loading, carrying and testing computer systems, and able to test plural desktop computer simultaneously.

The cart 100 includes a support frame 110, wheels 115 mounted on the bottom of the support frame 110, a loading member 120 arranged above the support frame 110 and forming eight loading space, input/output devices 130 arranged above the support frame 110 for inputting the test parameter and outputting the test result, a connection box 160 having plural input/output ports, a network router 140 connected to the internet, and a power supply 150. Although the loading member 120 forms eight loading spaces, more or less that eight may be implemented. For example, the loading member may form four of twelve loading spaces.

Each loading space consists of a rack 122, connection cables 124 to connect a system to be tested to the connection box 160, network cable 126 to connect a system to be tested to the network router 140, and a power cable 128 to connect a system to be tested to the power supply 150. The connection cables 124 include a monitor cable, mouse cable and keyboard cable. The mouse and keyboard cable can be selected from serial, PS/2 or USB type.

The connection box 160 includes eight sets of input/output ports for the system to be tested, and further includes one set of input/output ports for the input/output devices. The connection cable 124 connects each port. In case of mouse port, one mouse port for the input device is connected to 8 mouse ports respectively for the systems within the connection box 160. So, one mouse is connected to 8 systems via connection box. The keyboard, monitor, network router and power supply can be connected the same as the mouse.

The connection cable 124, network cable 126 and power cable 128 are put on the wiring room formed in the rack 122, and an external cable 152 connects the network router 140 and power supply 150 to the internet and external power source respectively. Using only one network router, plural computer systems can be tested with only one IP address. Therefore, networking test can be performed easily and quickly.

A control panel 162 may be located on the connection box 160 that may connect or disconnect the input/output device and the systems to be tested selectively. The control panel 162 allows the user to transmit the test signal to as many computer systems as he wants. For example, he can test only one computer, two computers, or all the computers.

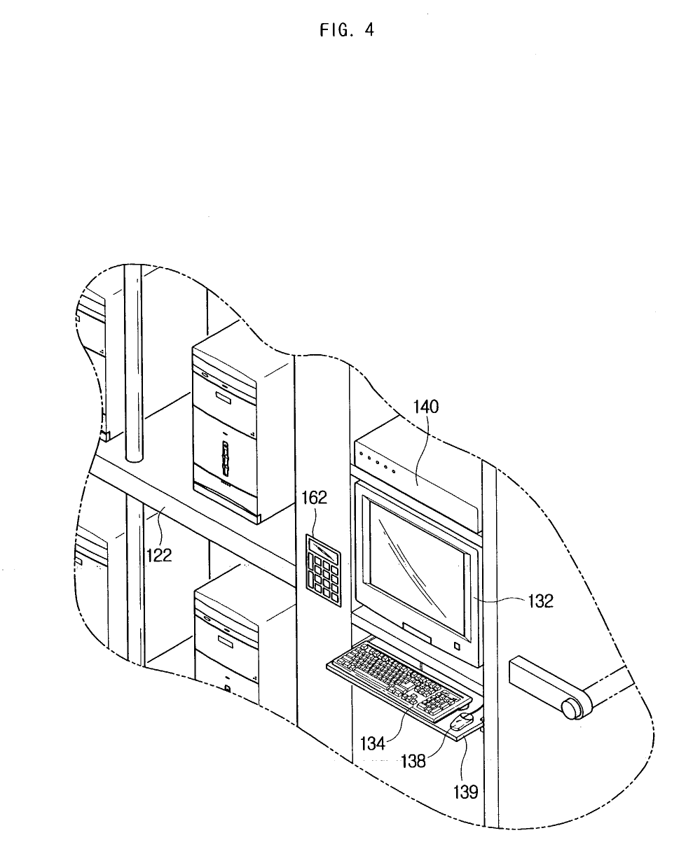

FIG. 4 is an enlarged perspective view of the input/output devices in FIG. 2.

Referring to FIG. 4, the keyboard 134 and mouse 138 are disposed in the drawer 139 mounted below the monitor 132. So the keyboard 134 and mouse 138 are kept inside of the loading member 120 with the drawer 139, and become available by pulling the drawer 139 out.

The first embodiment is described for testing the computer system, but it may be used for another electric or electronic devices that need power or transmit signal such as TV, refrigerator and electric kitchen appliances.

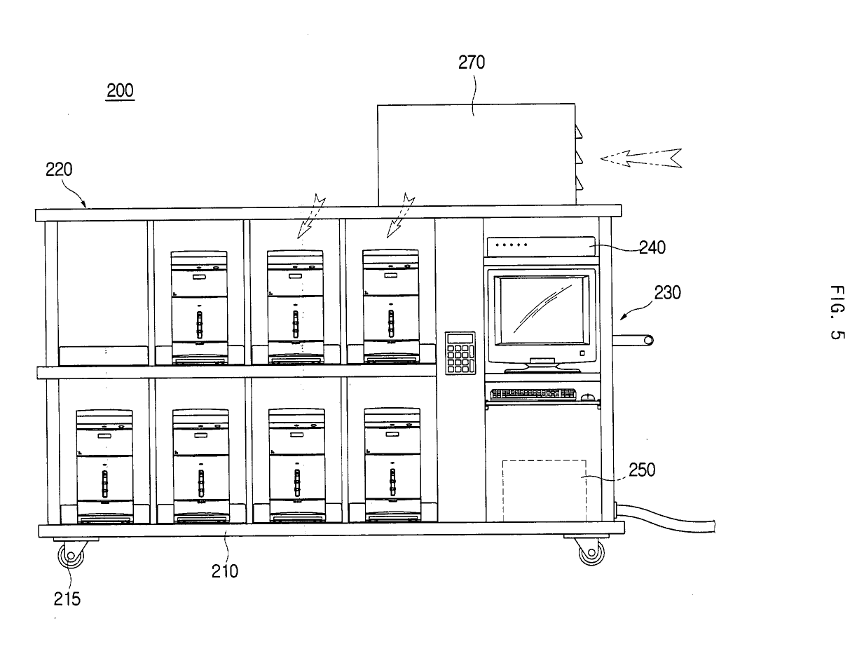

FIG. 5 is a front view of a cart for electric or electronic devices in accordance with the second preferred embodiment of the present invention.

Referring to FIG. 5, the cart 200 in the second preferred embodiment includes a support frame 210, wheels 215 mounted on the bottom of the support frame 210, a loading member 220 arranged above the support frame 210 and forming eight loading space, input/output devices 230 arranged above the support frame 210 for inputting the test parameter and outputting the test result, a connection box(not shown) having plural input/output ports, a network router 240 connected to the internet, a power supply 250 and constant temperature and humidity device 270.

Because all other components and their functions except for the constant temperature and humidity device 270, are the same as in the first embodiment detailed description will be omitted.

The constant temperature and humidity device 270 blows air of a predetermined temperature and humidity into the loading space. Therefore, testing without the computer at a constant temperature and humidity chamber is possible. Furthermore, detachable covers are mounted on the front and rear faces of the loading member to maintain a constant temperature and humidity condition.

According to the present invention, the loading and testing of electric or electronic devices can be performed simultaneously, resulting in a simplified testing process and significantly reduced testing time.

Nor is the present invention limited in its applications to the details of the construction and to the arrangements of the components set forth in this disclosure or illustrated in the drawings, as the present invention is capable of other embodiments and of being practiced and carried out in various ways, It is to be understood that the phraseology and terminology employed herein ate for the purpose of description and should not be regarded as limiting. Those skilled in the art will appreciate that the conception of this invention may readily utilized as a basis for the designing of other structures, methods and systems for carrying out the several purpose of present invention.

It is important therefore, that the claims be regarded as including such equivalent approaches and constructions insofar as they do not apart from the sprit and scope of the present invention.

What is claimed is:

1. A cart for loading, transporting and testing of plural electric or electronic devices, comprising;
a support frame;
carrying means mounted on the bottom of the support frame;
a loading member including racks for placing each electric or electronic devices on and having wiring spaces to keep connection cables in;
input/output devices to input the test signals to the electric or electronic devices and output the test results;
a connection box including plural sets of input/output ports for the electric or electronic devices and one set of input/output ports for the input/output devices; and
connection cables to connect each port via connection box.

2. The cart for loading, transporting and testing of plural electric or electronic devices as in the claim 1, wherein the input devices are at least one device selected from a group consisting of mouse and keyboard, and the output devices are at least one devices selected from a group consisting of monitor and printer.

3. The cart for loading, transporting and testing of plural electric or electronic devices as in the claim 2, wherein the input devices and output devices are integrated in a body.

4. The cart for loading, transporting and testing of plural electric or electronic devices as in the claim 1, wherein the connection box further includes a control panel that connects or disconnects each electric or electronic device selectively.

5. The cart for loading, transporting and testing of plural electric or electronic devices as in the claim 1, further comprising a network router connected to external network and network cables connecting the network router and the each electric or electronic device via the connection box.

6. The cart for loading, transporting, and testing plural electric or electronic devices as in the claim 1, further comprising a constant temperature and humidity device to maintain a constant temperature and humidity within the loading member.

7. The cart for loading, transporting and testing of plural electric or electronic devices as in the claim 1, wherein the loading member further including covers mounted on the front and rear faces of the loading member.

8. The cart for loading, transporting and testing of plural electric or electronic devices as in the claim 1, wherein the carrying means consist of plural wheels mounted on the bottom of the support frame.
